(19) United States
(12) Patent Application Publication
(10) Pub. No.: US 2020/0279272 A1
(43) Pub. Date: Sep. 3, 2020

(54) Predictive Maintenance of Visibility-Enhancing Surface Markings

(71) Applicant: Adams Center Properties, LLC, Adams Center, NY (US)

(72) Inventors: John S. McNeely, Sackets Harbor, NY (US); Kevin MacVittie, Austin, TX (US); Tyler Conlon, Potsdam, NY (US)

(73) Assignee: Adams Center Properties, LLC, Adams Center, NY (US)

(21) Appl. No.: 16/819,069

(22) Filed: Mar. 14, 2020

Related U.S. Application Data
(63) Continuation-in-part of application No. 16/045,386, filed on Jul. 25, 2018.
(60) Provisional application No. 62/536,759, filed on Jul. 25, 2017.

(51) Int. Cl. G06Q 30/00; G06Q 10/10; G06Q 50/26; G06Q 10/00; G06N 5/04; G06N 20/00

(52) U.S. Cl. CPC G06Q 30/018; G06Q 10/109; G06N 20/00; G06Q 10/20; G06N 5/04; G06Q 50/26

(57) ABSTRACT

Systems and methods for maintaining regulatory compliance of pavement markings may first determine an empirical decay rate for a conspicuity parameter, e.g., retroreflectivity, based on measured retroreflectivity values taken at two or more different time points, along with factor specific vectors. These factor-specific vectors corresponding to one or more decay rate factors are then obtained wherein each vector includes a time series of values associated with a corresponding decay factor. Factor-specific decay rates are then determined based on the empirical decay rate and the factor-specific vectors. The factor-specific decay rates are used to predict the marking's future retroreflectivity and to schedule future assessments of the marking accordingly. For example, the marking's lifetime may be estimated based on the future retroreflectivity values relative to a minimum acceptable retroreflectivity and a future assessment may be scheduled in accordance with the estimated lifetime.

This application: is a continuation in part of U.S. application Ser. No. 16/045,386, filed Jul. 25, 2018, which claims priority to U.S. Provisional Application No. 62/536,759, filed Jul. 25, 2017; Each of these earlier filed applications is, in its entirety, incorporated by reference herein.

### BACKGROUND

### Field of Invention

Subject matter disclosed herein pertains to the assessment and maintenance of surface markings for compliance with applicable regulations.

### Background

The use of surface markings placed on paved portions of highways and airfields to improve visibility and provide navigation guidance is well known. In the United States, the Federal Highway Administration (FHWA), a division of the U.S. Department of Transportation (USDOT) that specializes in highway transportation, oversees Federal-aid Highway Program funds used for constructing and maintaining Interstate Highways, U.S. Highways, and most state highways. The FHWA also publishes the Manual on Uniform Traffic Control Devices (MUTCD), which sets forth standards for road surface markings, traffic signs, and traffic signals, and Standard Highway Signs, which documents design specifications for pavement markings.

With respect to runway markings and other airfield markings, the Federal Aviation Authority (“FAA”) has established regulations, set forth in Title 14 of the Code of Federal Regulations (CFR), for airfield runway markings. Sections 139.1-139.343 of Title 14, often referred to simply as Part 139, requires most airports that serve aircraft with more than 30 seats to obtain an airport operating certificate indicating the airport's compliance with various FAA regulations. Notable with respect to subject matter disclosed herein, Part 139 requires each certificated airport to provide and maintain marking systems including specified runway markings, centerlines and appropriate edge markings for taxiways, holding position markings, and critical area markings for the airport's instrument landing system (ILS). See, 14 CFR § 139.311.

The FAA supplements Title 14 with an extensive volume of Advisory Circular documents setting forth the FAA's interpretation of Title 14 regulations. Advisory Circular 15/5340-1M (the “Marking Standards”) provides FAA guidance pertaining to surface marking regulations. Although compliance with the Marking Standards is not strictly required to obtain an operating certificate under Part 139, compliance with the Markings Standards constitutes compliance with the marking provisions of Part 139. In addition, compliance with the Marking Standards is mandatory for airport projects funded under one or more federal grant assistance programs including, but not limited to, the Airport Improvement Program and the Passenger Facility Charge program. Accordingly, owners and operators of certificated airports in the U.S. are understandably highly motivated to achieve and maintain compliance with the Marking Standards and, in other countries, commercial airports are generally required to provide and maintain comparable airfield markings in compliance with comparable regulations.

Unfortunately, however, conventional methods for assessing surface markings generally require the on-site acquisition of retroreflectivity data via direct measurement of retroreflectivity values taken at each of a potentially large number of surface markings. Acquiring retroreflectivity values on site is incredibly challenging. With respect to airfield markings, as an example, all but one or two of the 62 U.S. airports classified by the FAA as large hub or medium hub airports in 2017 maintains at least two operational runways and many of these maintain four or more operational runways and each operational runway may have as many as fifteen runway markings. In addition, because each of the runway markings described in the Marking Standards includes two or more reflective elements and each reflective element has a square footage “footprint” that is large, a marking's retroreflectivity compliance can rarely be satisfactorily determined with a single retroreflectivity reading and generally requires multiple readings. Moreover, because a runway on which on-site retroreflectivity assessment is being performed cannot be used for takeoff and landing operations, most such assessments must be performed during off-peak hours, further adding to the cost. Analogous issues apply to the assessment of surface markings on highways. Accordingly, it would be desirable to implement an assessment that does not necessarily require on-site measurements of the airfield's surface markings.

### SUMMARY OF THE INVENTION

The following disclosure includes descriptions of exemplary and illustrative embodiments of surface marking subject matter. Unless expressly stated otherwise, descriptions of embodiments that refer to a specific type of surface marking do not preclude other embodiments that employ a different type of surface marking. As a non-limiting example, descriptions of embodiments that refer to highway markings, roadway markings, pavement markings, or the like do not preclude embodiments that employ airfield markings, runway markings, or the like. Conversely, descriptions of embodiments that refer to airfield markings, runway markings, or the like do not preclude embodiments that employ highway markings, roadway markings, pavement markings, or the like.

Subject matter disclosed herein includes, in one aspect, a predictive process for assessing surface markings and for scheduling surface marking assessments based, at least in part, on forecasted or predicted values of a conspicuity parameter such as a surface marking's retroreflectivity. The surface marking itself may include, as a non-limiting example, waterborne, epoxy, thermoplastic, or methyl methacrylate paint, embedded with glass beads applied to a paved substrate. The thickness, composition, color, and design of a surface marking may vary according to the intended use of the marking.

Applicable surface markings may include surface markings subject to compliance with one or more governmental regulations and standards. In the context of pavement markings on highways and other roadways, surface markings may include edge line markings, center line markings, In the context of runway markings within an airfield, surface markings may include threshold markings, landing point markings, touchdown zone markings, centerline markings, edge markings, and so forth.

Predictive assessment processes disclosed herein may determine predicted values of surface marking retroreflectivity in accordance with a retroreflectivity decay rate model that is derived as disclosed herein. In at least some implementations, a decay rate determination process begins by calculating an initial decay rate, also referred to herein as an empirical decay rate, based on a combination of time and one or more factors that contribute to retroreflectivity decay. In one non-limiting embodiment, an empirical decay rate is determined based on a traffic factor indicative of the quantity of vehicular traffic to which a marking is exposed.

In an illustrative embodiment, an initial retroreflectivity value is measured at time t1 and a subsequent retroreflectivity value is measured at time t2. If the retroreflectivity value measured at time t2 equals or approximates the minimum acceptable retroreflectivity value for the marking, such as a minimum retroreflectivity required by a statute, rule, regulation, or agency advisory, the interval of time between t1 and t2 (t1,t2) represents the empirically determined lifetime of the marking, from which an empirical decay rate may then be determined by dividing the empirically determined lifetime by the time interval (t1,t2). Alternatively, if the retroreflectivity value measured at time t2 differs from the minimum acceptable retroreflectivity value, i.e., (e.g., the marking has not yet reached its empirically determined lifetime, the empirically determined lifetime may be extrapolated or otherwise inferred from the measured retroreflectivity values before calculating the empirical decay rate.

The decay rate determination process may then proceed by identifying one or more additional or secondary factors that contribute to retroreflectivity decay. For each identified secondary factor, a factor-specific vector may then be determined or otherwise obtained. Each factor-specific vector may include two or more values associated with the corresponding secondary decay factor. As an illustrative example, if precipitation is identified as a secondary factor, a precipitation vector comprising 12 values may be obtained from historical meteorological data wherein each of the 12 values in the vector corresponds to a different calendar month and each of the 12 values is indicative of an amount of precipitation expected to fall during the corresponding month. In this example, the factor specific vector may be described as a time series of values and, while this example uses 12-value vectors based on the 12 months in a calendar year, vectors having more or fewer values corresponding to shorter or longer calendar intervals may be used. More generally, factor-specific N-dimensional arrays may be obtained for any one or more of the identified secondary factors where each element of the array corresponds to a particular combination of N components. Extending the example of precipitation as a secondary factor, a 2-dimensional array may be obtained wherein the two components of the array correspond to the amount of precipitation and the type of precipitation, e.g., rain, sleet, snow).

The factor specific vector obtained for any particular secondary factor may be used in conjunction with a marking's historical retroreflectivity data to regress or otherwise calculate factor-specific decay rate information, i.e., information indicative of a magnitude of the influence that the applicable secondary factor has on the marking's retroreflectivity decay rate. These factor-specific decay rates may then be used in combination to forecast, predict, or estimate one or more future retroreflectivity values for the marking. Future assessments of the markings may be scheduled based, at least in part, on the one or more future retroreflectivity values. In addition, each such assessment may require a significantly fewer number of on-site retroreflectivity measurements for at least two reasons. First, because the surface marking's expected retroreflectivity values have been reliably predicted, the on-site assessment may require only enough data points to confirm the validity of the predicted values. Second, because the retroreflectivity decay rate model may reveal differences in the decay rates of individual markings within a single site, assessments may selectively target only those markings nearing their expected end of life. For example, if the prevailing meteorological conditions at an airport result in non-uniform usage of the airport's runways, that phenomenon may be captured by one or more secondary factors and may produce significantly lower retroreflectivity decay rates for markings located on any lesser-used runways. Even with a single runway, the direction from which aircraft land may be heavily biased and the runway markings corresponding to the non-dominant landing direction may require less frequent assessments.

The identification and selection of the secondary factors for which factor-specific vectors are obtained may be an important and non-trivial aspect of the process. Non-limiting examples of factors that may be evaluated for inclusion in the retroreflectivity decay rate model include various meteorological factors such as a solar factor indicative of a marking's exposure to direct sunlight, one or more thermal factors indicative of ambient temperatures in proximity to the markings, which may include a high temperature factor and a sub-freezing or other low temperature factor, one or more precipitation factors indicative of rain, sleet, snow, a plowing factor indicative of how frequently a runway marking was plowed for snow, and a wind factor corresponding to a wind exposure of the marking. Other secondary factors that may be employed include a position factor indicative of a position of a marking relative to a reference point, one or more factors indicative of an orientation, altitude, length, and composition of the applicable roadway or runway, a rubber accumulation factor corresponding to tire rubber buildup on each marking, and so forth. The factors may still further include one or more factors indicative of a composition and type of marking, including one or more factors indicative of paint composition, thickness, and application method and one or more glass bead factors indicative of glass bead type, spacing or density, deposition method, and so forth. Additional secondary factors may include factors indicative of maintenance activity associated with each markings, such as rubber removal operations etc.

In at least some embodiments, the scheduling of future assessments may include determining a predicted lifetime of a particular runway marking based on one or more future retroreflectivity values relative to a threshold retroreflectivity value, e.g., a minimum acceptable value of retroreflectivity specified by an applicable regulatory agency, body, or organization. In addition, as previously suggested, the scheduling of one or more future assessments may include scheduling future assessments for a first group of one or more surface markings and a second group of one or more surface markings for different dates in accordance with different expected lifetimes of the markings based on different factor-specific decay rates associated with the markings.

In some embodiments, factor-specific vectors determined for one surface marking may be re-used when predicting future retroreflectivity values of other surface markings. These embodiments may be inherently faster and less costly to implement because the influence of the secondary factors is quantified for a single marking only. In other embodiments, factor specific vectors may be determined for each individual surface markings or for small or large groups of markings. While this approach may be more time consuming and costly, it may produce a more accurate decay rate model that could potentially more than compensate for the additional time required by scheduling fewer assessments.

The determination of empirical decay rate and factor specific vectors described in the preceding paragraphs may be referred to herein as a rule-based determination of decay rate. While some embodiments may end the retroreflectivity decay rate determination process after performing rule-based determination, other embodiments may be include additional operations including, as an example, executing a machine learning algorithm to further refine the decay model. In at least one such embodiment, a machine learning algorithm may include a principal component analysis to identify a set of linearly independent principal components.

### BRIEF DESCRIPTION OF THE DRAWINGS

The following detailed description, in conjunction with the accompanying drawings, in which like reference numbers indicate like features, provide a more complete understanding of disclosed subject matter and advantages thereof, wherein:

FIG. 1 illustrates a visual inspection step in an assessment and predictive maintenance method;

FIG. 2 illustrates a detection unit being attached to a vehicle;

FIG. 3 illustrates a detection unit assessing airfield markings;

FIG. 4 illustrates a first exemplary sample of an airfield marking visual report;

FIG. 5 illustrates a second exemplary sample of an airfield marking visual report;

FIG. 6A illustrates a first exemplary retroreflectivity map;

FIG. 6B illustrates a second exemplary retroreflectivity map;

FIG. 7 illustrates technicians gathering data for an airfield marking;

FIG. 8 illustrates retroreflectivity measurements at different points in time for two airfield markings;

FIG. 9 illustrates measured and projected retroreflectivity values for a marking at different points in time;

FIG. 10 illustrate a flow diagram of a preventive maintenance method.

FIG. 11 illustrates a flow diagram of predictive assessment and scheduling method;

FIG. 12 illustrates an equation corresponding to a retroreflectivity decay rate model suitable for use in determining an initial decay rate;

FIG. 13 illustrate exemplary code for conveying various decay factors as factor-specific vectors;

FIG. 14 illustrates a plot of factor-specific and cumulative reflectivity decay as a function of time;

FIGS. 15A and 15B illustrate a surface marking assessment and maintenance platform suitable for implementing a retroreflectivity decay rate model that supports predictive scheduling of surface marking assessments; and

FIG. 16 illustrates machine learning elements of a retroreflectivity decay rate model.

### DETAILED DESCRIPTION OF THE PREFERRED EMBODIMENT

Methods and systems suitable for accurately predicting retroreflectivity values of surface markings applied to paved substrates are disclosed herein. Retroreflectivity values may be predicted based on a retroreflectivity decay rate model developed as described further below. Although the following description illustrates disclosed subject matter with references to retroreflectivity decay for paint-and-glass-bead markings applied to a paved substrate, such as a highway or runway, disclosed methods and systems for modeling retroreflectivity decay extend to substantially any suitable retroreflective surface marking.

The ability to accurately and reliably model retroreflectivity decay rates for surface markings as disclosed herein is commercially significant for a number of reasons. Conventional assessments of surface markings in which trained personnel, vehicles, and equipment are transported to potentially distant sites, is costly and includes many logistical challenges. In contrast, marking assessment methods disclosed herein, which can remotely generate reliable forecasts of retroreflectivity values for many surface markings, can potentially reduce assessment costs and improve assessment turnaround.

Accurately modeling reflectivity decay rates may include the identification and quantification of factors, also sometimes referred to herein as inputs, that contribute most significantly to the retroreflectivity decay of surface markings. Table 1 identifies an exemplary yet non-limiting list of potentially significant factors that may influence retroreflectivity decay rates for surface markings. Table 1 further indicates whether each factor may be more applicable to airfield markings or roadway markings.

TABLE 1

| Factor | Airfields, Roadways? |
|---|---|
| Age of marking | Both |
| Marking type | Both |
| Marking composition | Both |
| Marking position within surface | Airfield |
| Physical/Mechanical | |
| Surface maintenance (cleaning, plowing) | Both |
| Traffic wear | Both |
| Tire rubber accumulation | Airfield |
| Environmental | |
| Thermal | |
| Heat | Both |
| Cold | Both |
| Precipitation | |
| Rain | Both |
| Snow and sleet | Both |
| Humidity | Both |
| Wind | Airfield |
| Elevation | Both |

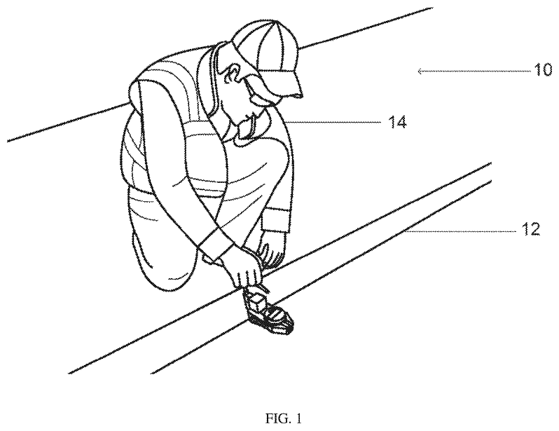

As suggested by FIG. 1, while many factors may influence retroreflectivity decay rates for both roadway markings and airfield markings, there may be one or more factors whose impact on retroreflectivity decay is considered to be more significant for either highway markings or runway markings. To illustrate, the accumulation of tire rubber may be a qualitatively more significant factor for airfield markings. Moreover, to the extent that rubber accumulation impacts retroreflectivity decay of roadway markings as well, the rubber accumulation factor for airfield markings may exhibit a correlate with a position factor indicative of the marking's relative location, e.g., the location of a marking within a runway. Aiming port markings, as an example, are likely to experience more tire rubber accumulation than other runway markings.

Identifying one or more factors as airfield-specific factors may be significant at least because the existing body of research into retroreflectivity decay rates has focused primarily on roadway markings where some factors potentially important to airfield marking decay were dismissed or not considered. Any factor that influences one or more takeoff or landing parameters may have an impact on the retroreflectivity of airfield markings. It is well known, for example, that higher elevations require longer minimum runways, which may result in a different decay rate distributionism for the corresponding markings. This is an example of a decay rate mechanism that one of ordinary skill in the field of roadway markings would not have been likely to consider.

Acknowledging the possibility of decay rate factors that may be specific to airfield markings, there may still be important similarities in the retroreflectivity decay of roadway and highway markings. Accordingly, disclosed subject matter encompasses, in at least some embodiments, any suitable type of surface marking and any suitable type of corresponding paved surface.

The inclusion or exclusion of a particular factor from the exemplary factors listed in Table 1 is not intended to be dispositive or suggestive of a factor's potential influence on retroreflectivity decay rate. Moreover, some factors that are considered good candidates for influencing retroreflectivity decay rates may be omitted from consideration because of difficulties in assessing the factor. For example, the environmental conditions that prevailed when a marking was applied to the applicable surface may be known to influence the marking's useful lifetime, but it may be impractical if not impossible to obtain reliable inputs indicative of this parameter.

The accuracy or reliability of any forecasting model is highly influenced by the quantity and accuracy of training data, i.e., data points used to develop the model. In the context of disclosed methods for forecasting retroreflectivity values, it may be particular important to obtain data indicative of each marking's age (time since last painting), the type of glass beads, the paint application process used, and the resulting parameters of the markings base including thickness, composition, uniformity, hardness, brittleness, etc.

Developing a retroreflectivity decay model that encompasses airfield markings may be an iterative process which can initial results are refined as more data is available. In such cases, each iteration may produce commercially significant and valuable decay rate information.

Referring to the figures, FIG. 1 illustrates a step in an embodiment of the assessment and predictive maintenance method.

FIG. 1 shows a trained technician 14 visually inspecting an airport marking 12. It is important that a thorough examination of the airfield markings 12 be completed in order to ensure FAA and ICAO compliance. Markings 12 at airfields 10 are verified in regard to their dimensions and placement and according to FAA regulations and Advisory Circulars, as well as ICAO regulations and Annexes. The data is recorded in a computer memory.

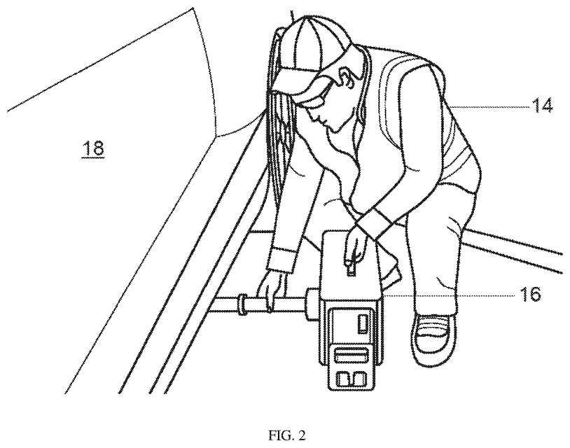

FIG. 2 shows a detection unit 16 being attached to a vehicle or mobile unit 18. The detection unit 16 is operated from a vehicle 18 so an evaluation of airport markings 12 can be accomplished in a shorter timeframe. When coupled with a GPS system, the system records markings 12 that are in compliance with applicable standards as well as those who show derivations from standard. The detection unit 16 is connected or attached generally to a low portion of the vehicle 18 such that adequate evaluations are obtained.

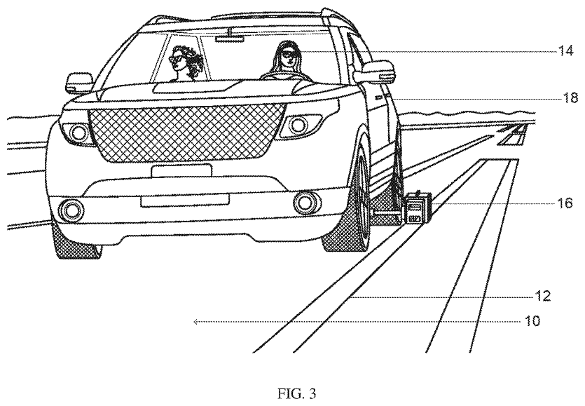

FIG. 3 shows a vehicle 18 with an attached detection unit 16, or combined a “mobile unit,” performing an assessment of the markings 12 on an airfield 10. The retroreflectivity readings are compiled by detection units 16 by a technician 14. This is particularly effective on longline and runway markings 12. The mobile units 18 are adapted to measure long-distance markings 12 and help ensure relatively shorter closure times of the airport 10 or specific runways to minimize interruptions to airport 10 operations.

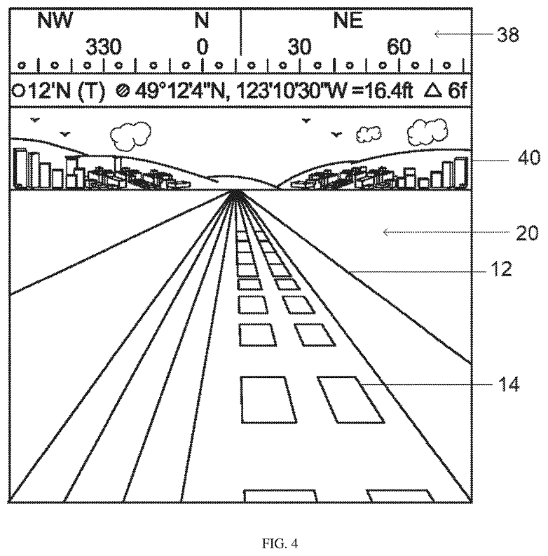

FIG. 4 illustrates a sample of a visual report of airport markings 12 for an embodiment.

Visual reporting may be done by trained, qualified and experienced technicians 14 who perform a visual evaluation of the current condition of the airfield markings 12. The technician 14 may note deficiencies, critical needs, and opportunities for improvement and record it. It is anticipated that a vehicle 18 connected display 20 will provide information to the technician 14 such as an indication that the mobile unit 18 has recognized and is tracking a marking 12, directional, and positioning information. The detection unit 16, locating unit 39, and recording unit 40 make up a retroreflectivity module. The data collected is recorded in a computer memory.

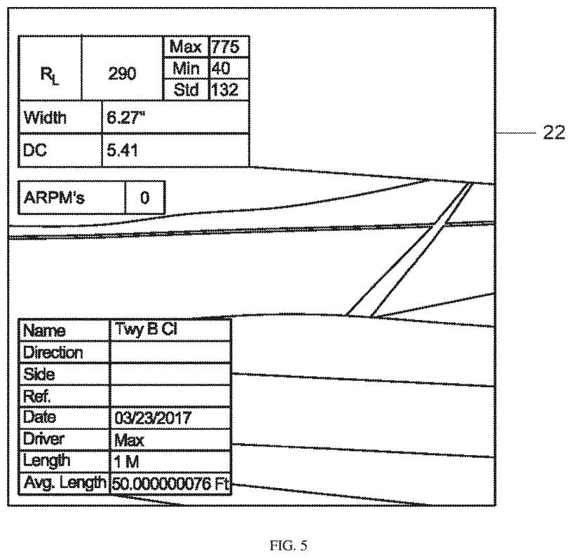

FIG. 5 illustrates a sample of a video report of airport markings 12. Video reporting 22 may include, without limitation, retroreflectivity levels and exact marker locations, which can be captured in a frame by frame, real-time video recording 22 that provides pertinent information needed to enhance airfield 10 safety.

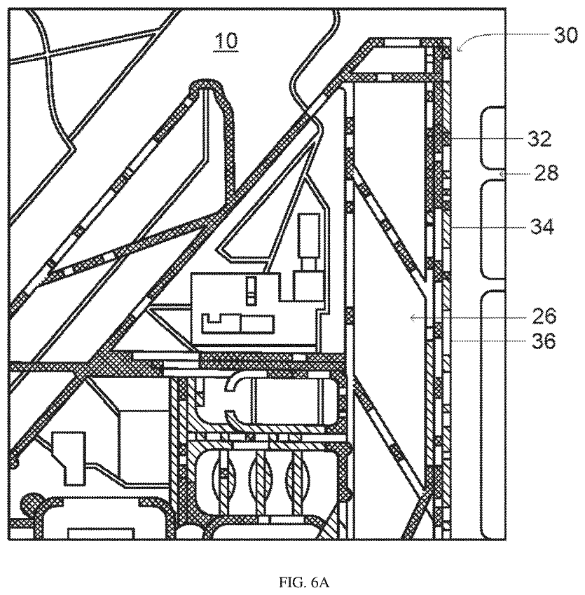

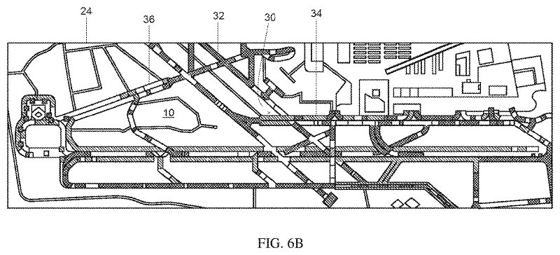

FIG. 6A illustrates a first sample of a GPS retroreflectivity map 24. The airfield markings' 12 retroreflectivity is tested to identify critical safety issues on runways 24, taxiways 26, service signs, and enhancements according to ASTM procedures. The results of such testing may be displayed on a map 24 using GPS data. The GPS map 24 of retroreflectivity readings 30 may be interactive for the user 14. Various levels of wear to the airfield markings 12 can be indicated in the retroreflectivity map 24. For example, a section of marking that is currently in need of repair 32 can be indicated, as well as sections that will need repair in the near future 34 or that are not in need of repair at the current time 36. Similarly, users 14 can find color coding of the various states (32, 34, 36) of the markings 12 to be helpful. For example, portions in immediate need of repair 32 shown in red, portions soon to be in need of repair 34 shown in yellow, and portions that are in compliance 36 show in green.

FIG. 6B illustrates a second sample of a GPS retroreflectivity map. It is anticipated that reflectivity maps of the same airport, or section of airport, can be combined over time to enable tracking areas of high wear versus lower wear. In this manner, unique maintenance plans can be developed providing for more frequent marking repair in areas of high wear and damage to the markings, and less frequent marking repair in areas of lower wear and damage. This data is used to create a schedule for removing and replacing less than all of the runway's markings in accordance with the schedule which will keep the runway in compliance with FAA standards and a lesser cost than replacing the entirety of the runway's markings whenever any portion of the runway markings cease to comply with FAA standards.

FIG. 7 shows technicians 14 gathering visual data for the airport marking 12 evaluation.

A detailed report can be generated utilizing data collected from both visual inspections done by technicians combined with reflectivity testing done by detection units 16 from mobile units 18.

The benefits of visual inspections combined with the benefits of reflectivity testing provide an overview of the current condition of the airfield markings 12.

The output of a maintenance model for a section of airport marking utilizes the data collected for the report from technicians 14 and mobile units 16, an airport marking maintenance plan can be generated based upon priority and critical needs. It is anticipated that software could be used to develop models for planning future maintenance to ensure markings compliance. Such a system allows the airport administration to track deteriorating markings, and help develop long-term, such as multi-year, airfield maintenance plans. Such plans, when followed, could help the airport save money, extend pavement and marking lifecycles, enhance overall airfield safety, while keeping the airfield markings in compliance with applicable standards.

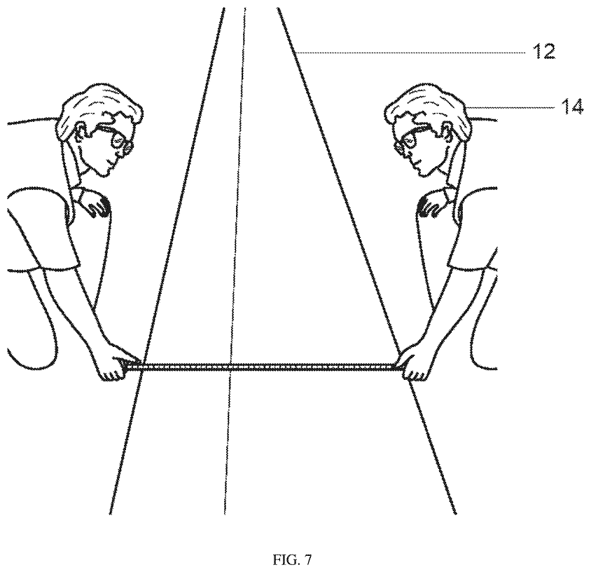

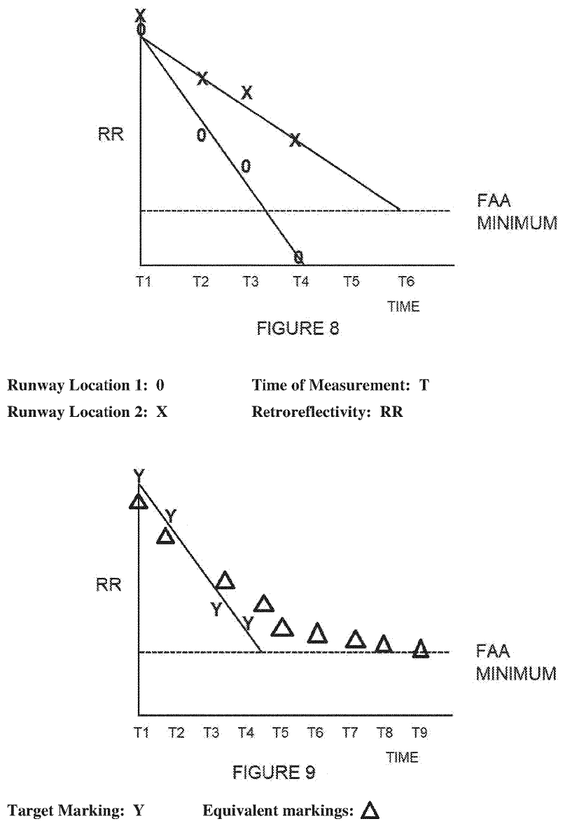

FIG. 8 is a graph showing retroreflectivity measurements taken at a runway marking location O at times T1-T4 and retroreflectivity measurements taken at a runway marking location X at the same times T1-T4, together with the FAA minimum standard for retroreflectivity at those marking locations. Currently, many airports remove and replace all markings at the airport, or all markings on particular group of runways, or a particular runway whenever any marking at the airport, group of runways or the runway needs to be removed and replaced. This is wasteful because the markings at location X can be instead removed and replaced on a longer cycle than the markings at location O. FIG. 8 shows that an extrapolation or projection can be made from the T1-T3 measurements showing that the marking at location O will need to be removed and replaced before the marking at location X will need to be removed and replaced. Such data and projections are used in scheduling repair and replacement of some, but not all, portions of the markings as those portions need to be removed and replaced.

Although the graph of FIG. 8 is directed at retroreflectivity measurements at specific marking GPS coordinates, it is analogously applicable to color, dimensions and the like. The same or other locations may be measured for color, width, friction and any other FAA or other relevant characteristics. As shown in FIG. 8, the several tests may be repeated at times T1-T4 and at intervals out to indefinite time Tn. Line fitting produces marking characteristic rate of change determinations and projections of how long the markings were remain compliant with FAA standards and not need to be removed and replaced at different particular GPS locations. These tests may be repeated at numerous GPS locations.

The graph of FIG. 8 further illustrates that after a certain number of measurements at location O and at location X, the deterioration over time of the markings at the respective locations can be projected or extrapolated. Currently, data specifically locating marking portions which may deteriorate more quickly than other marking areas is typically not organized or used for projection and preventive maintenance scheduling of removal and repair of only most urgent upcoming noncompliant portions of runway. Currently, data specifically locating marking areas with respect to retroreflectivity or other measurements is not typically used in differential or sequential maintenance marking scheduling. Currently, marking measurements and marking location data are not typically correlated over time with historical such measurements and location data, and are not typically used to project when the sum specific markings will cease to be in compliance with the FAA minimum requirements, while other specific markings at the same airport or on the same runway will continue to be in compliance.

FIG. 9 is a graph illustrating that, in an embodiment, a particular measurement, such as retroreflectivity, over time T-T4 can be plotted and projected to show those runway portions which will be not compliant with FAA minimum requirements at time T5. However, the FIG. 9 graph also illustrates that for this particular type of marking at this particular type of runway location, local weather patterns, usage, pavement, paint type, bead type and quantity, etc., there are equivalent markings at equivalent airports which have equivalent characteristics, and for which retroreflectivity deterioration plateaus. In the illustrative FIG. 9 graph, the similar markings, having a similar set of historical measurement data, do not cease to be compliant with FAA minimum requirements until time T9. Thus, for this particular marking at location Y on this particular runway, a documented data driven compliance program can show that the marking at location Y does not need to be removed and replaced at T4, but, rather, will be FAA compliant until T9. Similar measurements and methods will show that other portions of that airfield runways or that runway will be FAA compliant before or after T9, and thus will need to be removed and replaced before or after T9. The applicable units of time may be a month, 2 months, 3 months, 6 months, one year, 18 months or years out until indefinite time Tn. Because the cost of closing a runway and removing and replacing markings is immense, such a predictive maintenance system may be useful.

A benefit of the described system is that it is reproducible and data driven. As a practical matter, reducing marking maintenance costs by lengthening marking maintenance cycles for certain stretches of markings on airports or runways is only possible if the FAA approves the proposed lengthening of the marking maintenance cycle for different portions of different runways.

The system using data from numerous equivalent markings at equivalent runways at equivalent airports provides the robust historical numerical support needed to obtain such FAA approval.

Further, the described system of visually presenting its preventive maintenance, particularly in maps and graphs, will help airport procurement officers budget maintenance and obtain FAA approvals.

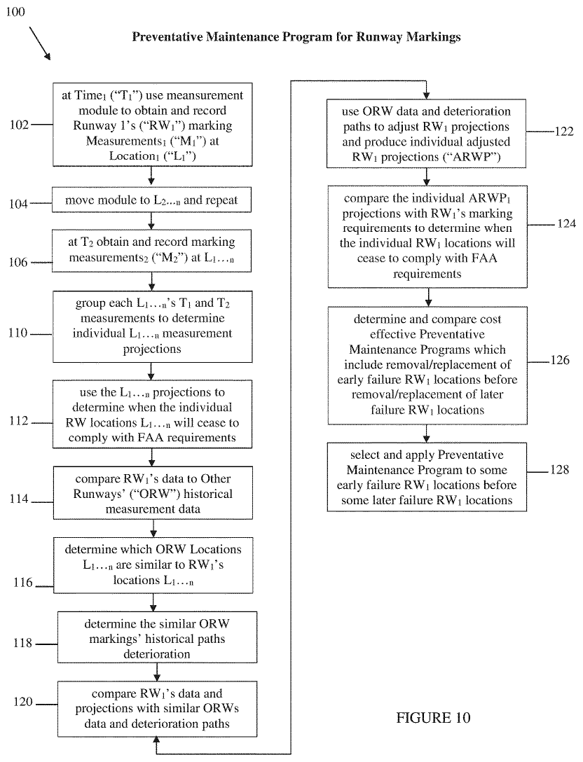

FIG. 10 shows a preventive maintenance program for runway markings flowchart 100.

The first step 102 is, at a Time T−1, obtain and record the first runway's markings measurements at location L1. The next step I04 is to move the measurement module to additional locations along the marking and repeat the tests and obtain and record the measurements. The next step 106 is to return to the marking at a later time, whether a month later, 6 months later, a year later or years later and repeat the tests and obtain and record the measurements. The next step 110 is to extrapolate or plot a best fit line of the measurements over time for each of the markings locations were measurements were making. The next step 112 is to use the projections or extrapolated best fit lines in a comparison with the FAA's requirements or other requirements to determine when the markings at each separate marking location will fail to comply with the FAA's requirements or other requirements. The next step 114 is to compare the first airport runway's data and projections with other similar airport runway's historical data. The next step 116 is to determine the other runways historical deterioration paths toward and past the FAA requirements. The next step 120 is to adjust the first runway's projections to take into account the deterioration paths of the other similar runways marking measurements. This may be done by averaging, clustering, at best-fit line projection or other grouping analysis which takes advantage of the fact that deterioration of similar markings on similar airport runways are likely to have some similarities in their deterioration pathways over time when relevant factors such as use, local weather, type of aircraft etc. are factored in.

The next step 122 is to use the adjusted projections to determine when the first airport's individual runway locations will fail to continue to comply with the FAA's requirements. The next step 124 is to determine and compare cost-effective preventive maintenance programs which include removal and replacement of early failure runway markings locations before later failure runway marking locations. The next step 126 is to select an appropriate preventive maintenance program and apply it to runway locations which the described method has determined are likely to fail before other runway locations.

Applying this described method keeps the airport's runways in compliance with FAA regulations at a substantially reduced cost relative to the cost of removing and replacing all of the airports runways or the runway whenever any portion of the airports runways or the runway ceases to be in compliance with FAA standards.

In an embodiment, the detection unit records individual data points and the individual data points are identified on a GPS overlay to include retroreflectivity, latitude and longitude locate location. The runway markings are correlated and mapped with feature runway areas such as taxiing area, landing area, turn area etc. The captured runway marking data points, past and present, are correlated with past and present data points of similar portions of similar runways to produce runway marking measurement projections which incorporate historical relationships at other similar runways and featured areas. An algorithm for predictive modeling based on the features and characteristics project and extrapolate with required runway marking requirements to produce projected time periods for required repair and maintenance of runway markings, which projections are unique for different runway zones appropriate for maintenance and repair. Work plans are developed from the measurements, correlated measurements and relationship based extrapolations that identify and prioritize maintenance needs based on the assessment measurements to create optimal beneficial impact work plans, cost estimates and projections for runway marking maintenance activities.

After an assessment, a report can be prepared and delivered to the user regarding key findings and proposed maintenance schedules. The report includes long-term work plans developed to prioritize maintenance needs. The data may be compiled using mobile retroreflectivity measuring units on all longline and runway markings to ensure short closure times and minimize interruptions to airport operations.

In an embodiment, keeping a runway's markings compliant with airfield runway and taxiway marking retroreflectivity requirements is accomplished by a technician using a retroreflectivity module. “Retroreflectivity” refers to the property of an airfield marking to reflect light back to a pilot or aircraft operator. Retroreflective markings are used to increase the markings' visibility—particularly at night. Maintaining marking retroreflectivity is important for airfield safety. The retroreflectivity module is made up of a detection unit for measuring retroreflectivity of runway markings, a location unit for identifying the position of measured runway markings, and a recording unit for recording the retroreflectivity measurements and the position measurements. As used herein, a “location unit” can be any of devices or methods that are known in the art to determine location such as, but not limited to, a GPS unit, cellular signals, Wi-Fi geolocation, Spot-Fi, and Geolocation APL

Numerous characteristics of a marking are measured and recorded when testing an airfield's markings. The quantity and types of beads in a paint stripe produce different radiographic signatures. The width of airport runway markings are many times larger than most markings on most highways, making most highway marking recording devices inappropriate.

Airport runway hold bars are tens of feet wide. The color of each marking is recorded on the color spectrum. The width of a marking's paint may vary from the width of the markings reflected beads. The thickness and other significant characteristics of the marking are checked by the FAA.

These two widths must be recorded separately. Each of the FAA's many requirements for airport markings must be measured, located on the runway, correlated with the location, recorded, compared with past and future recordings of that airport markings measurement of that marking characteristic at that location, compared with past and future recordings of other equivalent airport markings measurements of that marking characteristic at equivalent locations, and the results projected and extrapolated to produce a predictive maintenance program with that particular marking at that location in the context of the airport's marking removal and replacement requirements generally. These measurements are collected and used in different statistical analyses to quantify a predictive maintenance program which will cost less to sufficiently maintain compliance with FAA requirements.

At a first time, or Time a, the technician drives a vehicle with the mounted detection unit along the runway using the retroreflectivity module to sequentially record multiple individual retroreflectivity measurements from paint markings on an airport runway and individual runway position measurements. The readings are recorded at a multiplicity of specified positions. The position of the detection unit is also noted at each individual retroreflectivity measurement. For Time a, the multiple individual retroreflectivity measurements and their corresponding multiple runway position measurements are paired at location a. As used herein when referring to corresponding marking and position measurements, “corresponding” means measurements taken at approximately the same location. Thus, a record for Time a is created, correlating the runway's markings' retroreflectivity measurements, or a retroreflectivity measurement, with each retroreflectivity measurement's runway position measurement, or a location. The pairing and storing of the Time a digital record of the correlated runway's markings' retroreflectivity measurements and their runway position measurements may be done in a general-purpose or special-purpose computer. The runway's Time a correlated markings' retroreflectivity measurements are compared with FAA or similar airport runway marking retroreflectivity requirements, where it can then be determined which, if any, of the runway's Time a markings' retroreflectivity measurements indicate runway markings which require greater retroreflectivity to be compliant with the FAA or similar airport runway marking retroreflectivity requirements.

At a later date, or Time b, anticipated to be at least six months after Time a, a technician again moves a retroreflectivity module along the runway (or taxiway). As the retroreflectivity module moves along the runway (or taxiway), it is again used to sequentially record multiple individual retroreflectivity measurements, or b retroreflectivity measurements, from paint markings along the airport runway or taxiway along with corresponding individual position measurements, or b locations, so the position of each retroreflectivity measurement is known.

Because the positions from all of the retroreflectivity measurements from both Time a and Time b are known, individual retroreflectivity measurements at specific locations for both Time a and Time b are paired with their corresponding multiple Time a individual runway position measurements. Effectively, there is an a retroreflectivity measurement and a b retroreflectivity measurement taken at each location a. It is anticipated that this can be done on a general-purpose or special-purpose computer, creating a digital record of multiple Time b correlated runway's markings' retroreflectivity measurements and their Time b runway position measurements. The runway's Time b correlated markings' retroreflectivity measurements can be compared with FAA or similar airport runway marking retroreflectivity requirements to determine if any of the markings require retroreflectivity to be added at certain positions.

The Time a and Time b records of the correlated runway's markings' retroreflectivity measurements and their runway position measurements are compared and paired so records from Time a of the location a retroreflectivity measurements and their corresponding location a positions and from Time b of the location b retroreflectivity measurements and their corresponding a positions (records are paired by location, so pairings are where the a positions are the same or about the same as the location b positions). The changes in the retroreflectivity measurements from Time a to Time b at the various a positions can be used to help determine the amount of degradation, if any, of the runway's markings has occurred in the past and is likely to occur in the future. It is anticipated that retroreflectivity measurements will be taken at positions at intervals over the entire airfield. The amount of time between Time a and Time b and the amount of degradation of the markings at a given position can be used to determine a degradation to time relationship. The degradation to time relationship can be used to determine which locations of the markings are degrading faster, and thus are more likely to need greater retroreflectivity to be compliant with the FAA or similar airport runway marking retroreflectivity requirements in the future and how long into the future. Or, the relationships between the Time a correlated markings' retroreflectivity measurements with the Time b correlated markings' retroreflectivity measurements and the temporal difference between Time a and Time b′ are used to determine the runway's markings' retroreflectivity degradation to time relationship. The runway's markings' retroreflectivity degradation to time relationship is used to predict how long the runway's markings' retroreflectivity will be compliant with the FAA or similar airport runway marking retroreflectivity requirements.

It is also anticipated that handheld detection units and location units can be used to acquire retroreflectivity measurements and locations in order to supplement retroreflectivity modules (which are comprised of a detection unit for measuring retroreflectivity of the marking, a location unit for identifying the location of the measured runway marking, and a recording unit for recording the retroreflectivity measurement and the runway position measurement). The measurement modules may be located on a mobile platform, such as a vehicle, drone, wheeled or slidable wagon, a handheld unit or other platform which can hold the measurement modules and be moved along pavement markings.

While the vehicle mounted retroreflectivity modules are efficient for long line markings, hand-held modules may be more efficient for use on short markings and indicators such as numbers or letters. Thus, the method herein anticipates using one or both of handheld and vehicle mounted retroreflectivity modules.

Predictions of how long specific positions of the runway's individual markings' retroreflectivity will be compliant with the FAA or similar airport runway marking retroreflectivity requirements can be used to create a markings retroreflectivity maintenance program which identifies first individual portions of the runway markings which will require retroreflectivity maintenance within a given time period (such as a year) to be compliant with FAA or similar airport runway marking retroreflectivity requirements. The predictions can further identify second individual portions of the runway markings which are predicted to not require retroreflectivity maintenance within that same time period.

Airfields similar to the subject airfield for which a maintenance program is being prepared can be identified. Markings which are similar to the markings evaluated at airfields which are similar to the subject airfield can be identified. It is anticipated that the retroreflectivity maintenance program of similar airfields and similar markings may be used to predict future maintenance for the other similar airfields and similar markings. Similarity can include size, local weather, proximity to geographical features that can affect markings, amount of air traffic, types of aircraft that use the airfield, type of runway, location on the runway, type of use, type of pavement, type of paint, type of maintenance etc. Similar markings could be determined by their type, location on the airfield, amount of traffic, and types of aircraft that contact the markings.

Another use of the prediction maintenance program of how long the runway's individual markings' retroreflectivity will be compliant with the FAA or similar airport runway marking retroreflectivity requirements is to create a long range (or multi-time period, or multi-year) runway marking retroreflectivity maintenance program.

A method to keep a marking on a runway compliant with an airfield's runway marking retroreflectivity requirements is by creating a map of the airfield with indicators at the multiple a positions on the map illustrating whether or not the marking at each individual a position requires greater retroreflectivity to be compliant with the airfield's runway marking retroreflectivity requirement. To make the map more useful for users, the indicators may be color coded. For example, green for positions that do not need greater retroreflectivity to be compliant, yellow for areas that are predicted to need greater retroreflectivity to be compliant within a given time period, such as six months or a year, and red for locations that currently need greater retroreflectivity to be compliant.

It is anticipated that in order to fully integrate the data recovered by the collection and testing, software would be used to evaluate such data recorded on a specific airfield. Additionally, other factors unique to the specific airfield can be incorporated using constants consistent among airfields to help evaluate the airfield. In order to develop a predictive maintenance plan, software could be used that directs data collection as well as evaluate it. However, whether software is used or not, a system of temporally evaluating the data in order to generate predictive maintenance plans could be implemented affected. Such predictive maintenance plans allow the airport's administration to know when and where specific areas of the airport markings need maintenance. This allows for improved budgeting and significant cost savings by focusing maintenance on areas of the airfield markings with critical needs while eliminating unnecessary and wasteful remarking of the entire airfield.

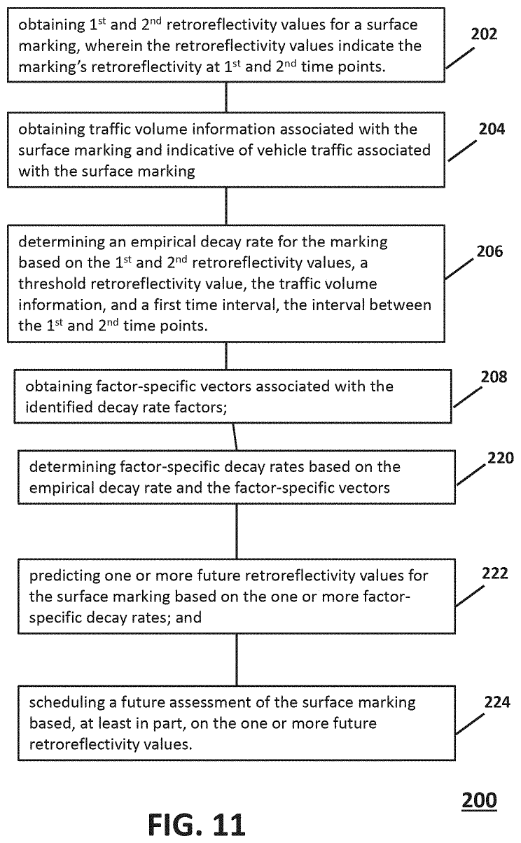

Referring now to FIG. 11, a method 200 for predictively maintaining surface markings is illustrated. The predicative maintenance is achieved in accordance with a retroreflectivity forecasting model developed in according with the method 200 as illustrated in FIG. 11. The method 200 illustrated in FIG. 2 includes a determination of an empirical decay rate. The empirical decay rate is then refined by identifying one or more secondary factors and a factor specific vector all or at least some of the secondary factors. The factor specific vectors may include or represent a time series of values. Each value may be analogous to a weighting of the applicable factor's contribution to retroreflectivity decay for a particular interval. In at least one embodiment, a factor specific vector may include twelve values wherein each value corresponds to a calendar month and indicates a relative significance of the decay factor during that month. As an example, the factor specific vector for a precipitation factor may, depending upon the prevailing climate, include relatively high values corresponding to the months of spring and relatively lower values corresponding to the summer month by a determination of one or more factor specific decay.

Once the retroreflectivity decay model is sufficiently refined through one or more iterations, the resulting decay model is used in conjunction with appropriate inputs to forecast or predict future retroreflectivity values for one or more markings. In some embodiments, retroreflectivity values for a marking may be forecasted up to until a forecasted value for a marking fails to satisfy a criterion such as a minimum acceptable retroreflectivity specified by the FAA, ICAO, or another regulatory body.

With specific reference now to the predicative maintenance method 200 illustrated in FIG. 2, two or more retroreflectivity values are obtained (operation 202) for a surface marking at two or more different points in time. Each retroreflectivity value indicates a retroreflectivity of the surface marking at a corresponding time point.

Information indicative of a traffic volume associated with the marking is then obtained (operation 204). In the case of an airfield making, the traffic volume information may be indicative of aircraft traffic taking off from or landing on the runway in which the applicable marking is located. Traffic volume data may be acquired from flight logs or another suitable source of regularly maintained airport records. Preferably, runway identification information is available in the traffic data. If, however, the traffic volume information does not indicate runway information for each departure and arrival, the traffic volume information for a particular marking may be approximated based upon a suitable apportionment method. If, as an example, an airport has two parallel runways, each being used approximately equally, half of the total takeoffs and landings may be used as the traffic volume information for the marking. As another example, an airport with two non-parallel runways may use one of the runways, on average, for approximately 70% of takeoffs and landings based on the characteristics of prevailing winds. In this example, a traffic volume may be attributed to the surface marking based 70% of the total number of takeoffs and landings. These examples are intended to be illustrative and expressly not limiting of how a traffic parameter might be associated with a particular surface marking.

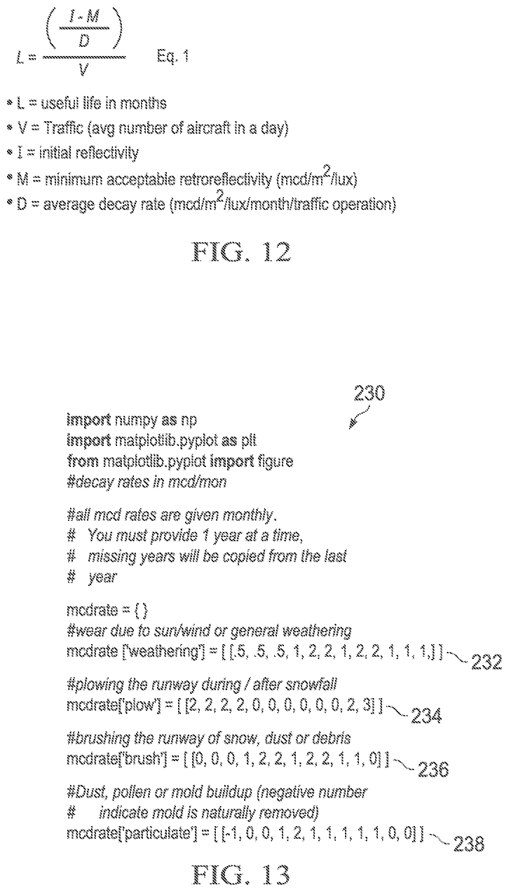

The method 200 illustrated in FIG. 11 then determines (operation 206) an empirical decay rate for the surface marking based on a first and second retroreflectivity values, a threshold retroreflectivity value, the traffic volume, and the time interval, which corresponds to the difference in time between the first and second time points. The empirical decay rate may be estimated from an equation such as Equation 1 shown in FIG. 12, wherein the variable I is the first retroreflectivity value at time t1, the variable M, which is the minimum acceptable retroreflectivity value (M) represents the second retroreflectivity value, and the interval between t1 and t2 is equal to the marking's lifetime (L). To derive the empirically determined decay rate in accordance with Equation 1, FIG. 12, an initial retroreflectivity value (I) may be taken at time t1 and subsequent readings of the marking's retroreflectivity may be taken from time until the retroreflectivity has decayed to the minimum acceptable value (M). The point in time at which a retroreflectivity value of M is first detected is recognized as the second time point t2 and the interval between t1 and t2 therefore corresponds to the empirically determined lifetime (L), i.e., the time required for the marking's initial retroreflectivity to decay to the minimum acceptable retroreflectivity value. The empirical decay rate D is computed as [(I−M)/L]/V, where V indicates the traffic volume.

While this approach to determining the empirical decay rate (D) may be highly accurate because it derives the decay rate D based upon the actual measured lifetime of the marking, it may also be undesirably time consuming because retroreflectivity readings must be taken until the marking's retroreflectivity decays all the way to M. In other implementations, L may be derived from the initial retroreflectivity (I) and a second retroreflectivity value taken at an arbitrary time t2 by extrapolating the drop in decay linearly, at the decay rate observed between t1 and t2, until the total decay equals (I−M). The point in time at which the extrapolated decay line reaches the minimum acceptable retroreflectivity value is taken as the empirical lifetime (L). With this derived value of L, the decay rate (D) may then be computed according to Equation 1 from the values of I, M, L and V as explained above.

After the empirical decay rate is determined, one or more decay rate factors are selected (operation 208). In some embodiments estimates of the significance of each decay factor may be obtained, e.g., using a regression algorithm or any other suitable statistical model approach and weighting may be assigned to one or more decay factors in accordance with the weightings.

After identifying and optionally weighting the decay factors, factor-specific vectors may then be retrieved, derived, associated with, or otherwise obtained (operation 220). In at least some embodiments, each factor-specific vector comprises a time series of values associated with a corresponding decay rate factor.

FIG. 13 illustrates an exemplary Python template 230 for implementing a set of factor-specific vectors. The template 230 illustrated in FIG. 13, the factor-specific vectors include a general weathering vector 232, a runway plowing vector 234, a runway brushing vector 236, and a vector 238 corresponding to the buildup of dust, pollen and mold. Each illustrated vector includes a value corresponding to each month of the year. Depending on the factor and the location and other parameters associated with the surface marking, the magnitude of the vector values may vary from month to month in accordance with a predicted severity or prevalence of the corresponding decay factor. The vector 238 even includes a negative value corresponding to a month in which the decay factor, mold accumulation or buildup, is removed or lessened by natural processes.

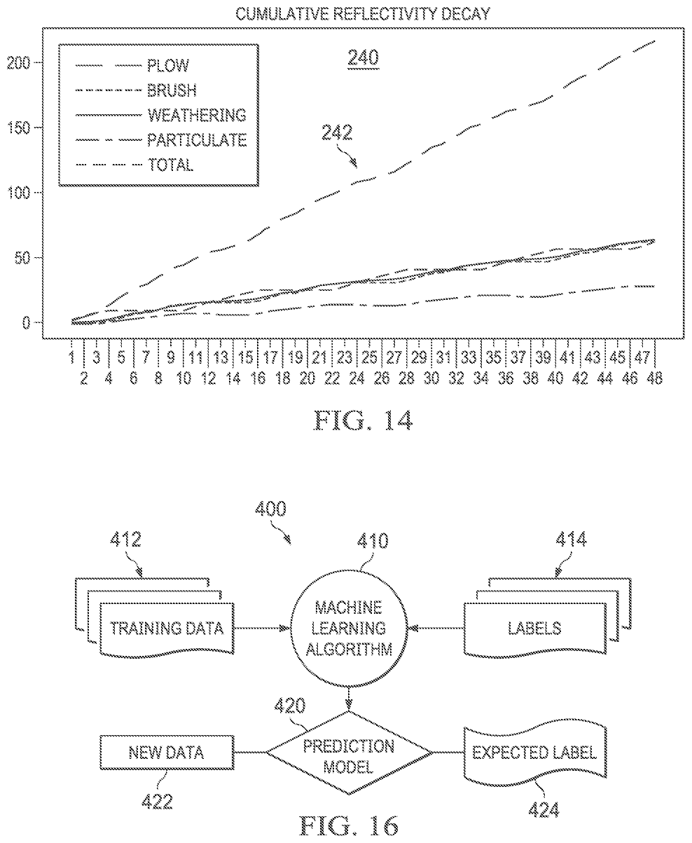

Returning to FIG. 11, one or more future retroreflectivity values may be predicted (operation 222) for one or more surface markings based on the one or more factor-specific decay rates. FIG. 14 illustrates an example output illustrating a set of plots corresponding to predicted retroreflectivity decay associated with each of the identified decay factors as well as a plot of cumulative decay encompassing all of the individual decay factors. Thereafter, a future assessment of the surface marking may be scheduled (operation 224) based, at least in part, on the one or more future retroreflectivity values.

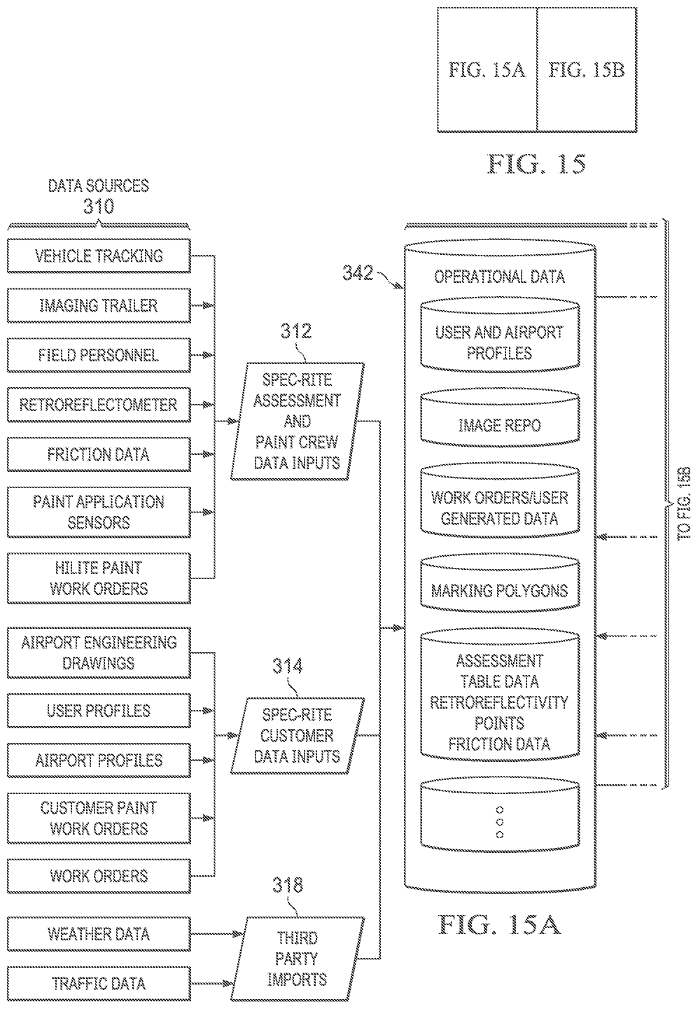

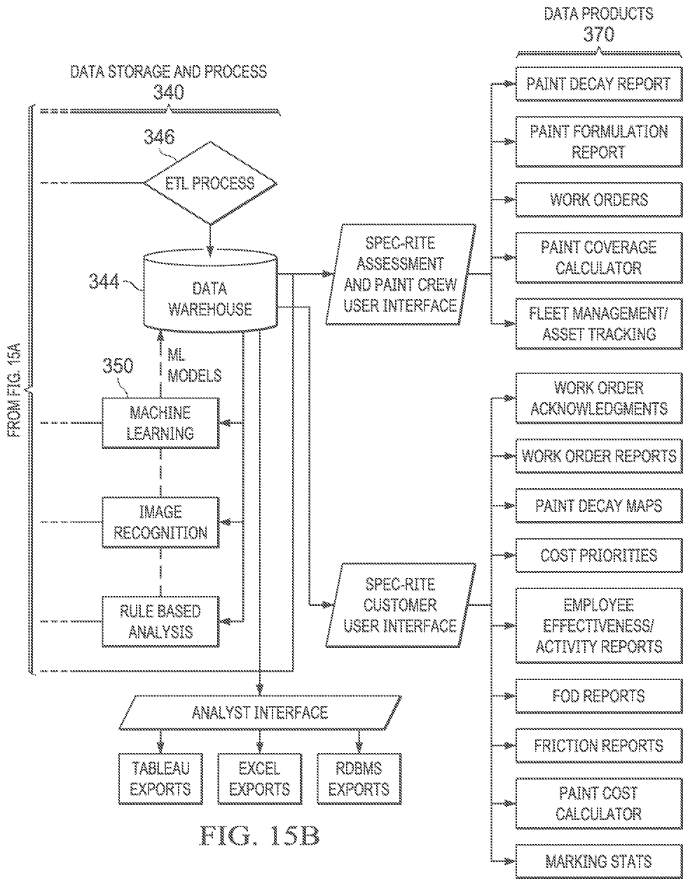

Referring now to FIGS. 15A and 15B, elements of a predictive assessment platform 300 are illustrated to convey, in part, the utilization of data collected from various sources including, without limitation, assessments, personnel and software. As illustrated in FIGS. 15A and 15B, predictive assessment platform 300 includes storage and process components 340 that receive information from data sources 310 and generate data products 370. The data sources 310 illustrated in FIG. 15A comprise resources for collecting, sourcing, or otherwise gathering any information that may contain data pertaining to the assessment and maintenance of surface markings.

The storage and processing components 340 illustrated in FIG. 15B provide storage and computation resources for the predictive assessment platform 300. The storage resources illustrated in FIGS. 15A and 15B include operational data storage 342, configured to capture or otherwise record transactional data indicative of day-to-day operations. An ETL module 346 extracts data from operational data storage 342, transforms the data as appropriate, and loads the extracted data into data warehouse 344 for analytical processing. Data analysis performed by data warehouse 344 generates, in part, value added data products 370, which can be monetized via sales, licenses, subscriptions and the like.

The data sources 310 illustrated in FIG. 15A include assessment data 312, customer data inputs 314, and third-party sources 318. Assessment data 312 represents data generated by assessment activities including on site and in-field analyses of surface markings and other relevant assets. Customer data inputs 314 correspond to input based data provided by an end-user, such as work order activities, or other location-specific data. Third party sources 318, as suggested by the name, includes data, such as weather or traffic volume data, provided by a third party.

The manner in which data is stored in storage and processing components 340 is an implementation detail that is generally dictated or significantly influenced by manner in which operational data 342 is utilized and the long-term analytic operations performed by data warehouse 344. FIGS. 15A and 15B illustrate operational data 342 as distinct from data warehouse 344. It will nevertheless be appreciated by those of skill in the field, that storage and process resources 340 may correspond to distinct virtual or physical storage resources implemented partially or fully on-site, distributed access a typically small number of physical data centers, or implemented as cloud-based resources.

The ETL process 346 illustrated in FIG. 15B may transfer at least some of the operational data 342 from time to time to data warehouse 344. Other data stored in operation data 342, such as data indicative of direct observations, may not require analytical processing, in which case, it may be unnecessary to transfer such data to data warehouse 344.

The predictive assessment platform 300 illustrated in FIGS. 15A and 15B further includes additional data storage and processing resources collectively identified as machine learning models 350. Machine learning models 350 may correspond to sophisticated data warehouses or knowledge bases derived from operational data 342 over time. Unlike at least some data stored in data warehouses 344, machine learning modules 350 models might not store direct copies of operational data 342 but instead may include a wide range of data and corresponding rules for weighting and using that data to make decisions. Machine learning models 350 often represent the highest value stored data because learning models 350 may encapsulate, in addition to observed data, rules for making decisions based on the observed data. Building a machine learning module 350 generally includes an initial step in which a specific problem is very clearly identified, feature data parameters and label data are defined. As a non-limiting example, developing a model that accurately and reliably predicts the rate at which the reflectivity of a painted surface marking will decay on a particular marking, parameters roughly analogous to the decay ‘factors’ like traffic, snow, bead type, marking type etc are identified. The labels are also very important. These are the observed decay for a particular marking.

The data products 370 illustrated in FIG. 15B provide value but they can also be used to create new data sources which in turn can provide new products. One consideration when building new software features is how the new feature can be leveraged to provide data which can in turn be used to provide a new product. This consideration may be referred to as a data strategy for software features. As a non-limiting example in the context of airfield markings, a work order submission for an airfield employee who finds a large crack in the paint of a surface marking on Taxiway A. The airport manager may only require a description and location as dictated by a corresponding business process. However this software feature may be used as a tool to collect data intelligently by being actively aware of the data strategy. One strategy might be to have the employee ‘tag’ the crack in the image and select its type or length. This supplemental information may improve the quality of data significantly and, perhaps equally important if not more so, may be used to build a new data source—image annotations. In this example, the annotations may become a unique and freely obtained piece of potentially valuable data when properly used to train an image recognition model. A good data strategy is important when building out new software platform features.

FIG. 16 illustrates elements of a predictive assessment model 400 that includes a machine learning algorithm 410 developed at least in part in accordance with a set of training data 412. Labels 414 provided to machine learning algorithm 410 may represent instances of observed retroreflectivity decay for a particular surface marking. The machine learning algorithm 410 may be configured to process the label data 414 in accordance with algorithm optimized for the training data 412 to produce a prediction model 420. New data 422 may then be provided to prediction model 420 to obtain forecasts or predictions of expected labels 424.

Statements concerning the described apparatus and method are sometimes made in the present tense. Use of the present tense is for simplicity, however, as some of the apparatus, methods, steps and results are anticipated apparatus, methods, steps and results rather than statements of past tests and use.

The terms “about” or “approximately” are defined as being “close to” as understood by one of ordinary skill in the art, and in one non-limiting embodiment, the terms are defined to be within 10%, preferably within 5%, more preferably within 1%, and most preferably within 0.5%.

Accordingly, unless indicated to the contrary, the numerical parameters set forth in this specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

The term “substantially” and its variations are defined as being largely but not necessarily wholly what is specified as understood by one of ordinary skill in the art, and in one non-limiting embodiment, substantially refers to ranges within 10%, within 5%, within 1%, or within 0.5%.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

What is claimed is:

1. A surface marking compliance method, wherein the method comprises:
obtaining a first retroreflectivity value and a second retroreflectivity value for a surface marking, wherein the first retroreflectivity value indicates a retroreflectivity of the surface marking at a first time point and the second retroreflectivity value indicates the retroreflectivity of the surface marking at a second time point;
determining an empirical decay rate for the surface marking based on the first and second retroreflectivity values, a threshold retroreflectivity value, and a first-time interval, wherein the first time interval corresponds to a difference in time between the first and second time points;
obtaining one or more factor-specific vectors associated with one or more decay rate factors, wherein each factor-specific vector includes a time series of values associated with a corresponding decay factor; and
determining one or more factor-specific decay rates based on the empirical decay rate and one or more factor-specific vectors;
predicting one or more future retroreflectivity values for the surface marking based on the one or more factor-specific decay rates; and
scheduling a future assessment of the surface marking based, at least in part, on the one or more future retroreflectivity values.

2. The surface marking compliance method of claim 1, wherein scheduling the future assessment includes:
determining a predicted lifetime of the surface marking based on the one or more future retroreflectivity values and a minimum acceptable retroreflectivity; and
scheduling the future assessment in accordance with the predicted lifetime.

3. The surface marking compliance method of claim 1, further comprising:
obtaining initial retroreflectivity values from one or more additional surface markings;
predicting one or more future retroreflectivity values for the one or more additional surface markings; and
scheduling one or more future assessments of the one or more additional surface markings based on the one or more future retroreflectivity values for the one or more additional surface markings.

4. The surface marking compliance method of claim 3, wherein the scheduling of one or more future assessments for the one or more additional surface markings includes scheduling future assessments for a first surface marking and a second surface marking for different dates in accordance with different factor-specific decay rates associated with the first and second surface markings.

5. The surface marking compliance method of claim 3, wherein predicting the one or more future retroreflectivity values for the one or more additional surface markings comprises predicting the one or more future retroreflectivity values based on the one or more factor-specific decay rates determined for the initial surface marking.

6. The surface marking compliance method of claim 3, wherein predicting the one or more future retroreflectivity values for the one or more additional surface markings comprises predicting the one or more future retroreflectivity values based on one or more factor-specific decay rates determined for the one or more additional surface markings.

7. The surface marking compliance method of claim 1, further comprising: performing a machine learning algorithm to generate, based on the retroreflectivity values and the factor-specific decay rates a retroreflectivity decay model for predicting future retroreflectivity values.

8. The surface marking compliance method of claim 7, wherein performing the machine learning algorithm is configured to perform a principal component analysis to identify a set of linearly independent principal components.

9. The surface marking compliance method of claim 1, wherein the one or more factor-specific decay rates include decay rates for one or more of decay factors selected from a group of decay factors comprising: a plow decay factor corresponding to a number of times the surface marking was plowed; a solar decay factor corresponding to a solar energy exposure of the surface marking, a wind decay factor corresponding to a wind exposure of the surface marking; a position factor corresponding to a position of the marking relative to a reference position, an elevation decay factor corresponding to an elevation of the surface marking; a thermal decay factor corresponding to a temperature associated with the surface marker; an icing decay factor corresponding to freezing temperatures to which the surface marker is exposed; a marking type decay factor corresponding to a type of the surface marking; and a marking composition decay factor corresponding to a composition of the surface marking.

10. The surface marking compliance method of claim 9, wherein:
the surface marking comprises a highway marking selected from: an edge marking, a center line marking, and a lane marking; and
the surface marking comprises thermoplastic paint applied to a highway substrate wherein the thermoplastic paint includes glass beads and silica sand embedded in a film of epoxy or methyl acrylate based paint having a thickness in a range of approximately 15 to 40 mils.

11. A surface marking compliance system, wherein the system comprises:
a central processing unit; and
computer readable storage coupled to the central processing unit, wherein the computer readable storage includes executable program instructions that, when executed, cause the system to perform surface marking compliance operations, wherein the surface marking compliance operations include:
obtaining a first conspicuity value and a second conspicuity value for a surface marking, wherein the first conspicuity value indicates a conspicuity of the surface marking at a first time point and the second conspicuity value indicates the conspicuity of the surface marking at a second time point;
determining an empirical decay rate for the surface marking based on the first and second conspicuity values, a threshold conspicuity value, and a first time interval, wherein the first time interval corresponds to a difference in time between the first and second time points;
obtaining one or more factor-specific vectors associated with one or more decay rate factors; wherein each factor-specific vector includes a time series of values associated with a corresponding decay factor; and
determining one or more factor-specific decay rates based on the empirical decay rate and one or more factor-specific vectors, wherein each factor-specific vector comprises a time series of values associated with a corresponding decay rate factor;
predicting one or more future conspicuity values for the surface marking based on the one or more factor-specific decay rates; and
scheduling a future assessment of the surface marking based, at least in part, on the one or more future conspicuity values.

12. The surface marking compliance system of claim 11, wherein each conspicuity value indicates a retroreflectivity of the surface marking.

13. The surface marking compliance system of claim 11, wherein the surface marking compliance operations include:
obtaining initial conspicuity values from one or more additional surface markings;
predicting one or more future conspicuity values for the one or more additional surface markings; and
scheduling one or more future assessments of the one or more additional surface markings based on the one or more future conspicuity values for the one or more additional surface markings.

14. The surface marking compliance system of claim 13, wherein the scheduling of one or more future assessments for the one or more additional surface markings includes scheduling future assessments for a first surface marking and a second surface marking for different dates in accordance with different factor-specific decay rates associated with the first and second surface markings.

15. The surface marking compliance system of claim 13, wherein predicting the one or more future conspicuity values for the one or more additional surface markings comprises predicting the one or more future conspicuity values based on the one or more factor-specific decay rates determined for the initial surface marking.

16. The surface marking compliance system of claim 13, wherein predicting the one or more future conspicuity values for the one or more additional surface markings comprises predicting the one or more future conspicuity values based on one or more factor-specific decay rates determined for the one or more additional surface markings.

17. The surface marking compliance system of claim 11, wherein the surface marking compliance method includes:
performing a machine learning algorithm to generate, based on the conspicuity values and the factor-specific decay rates a conspicuity decay model for predicting future conspicuity values.

18. The surface marking compliance system of claim 17, wherein performing the machine learning algorithm includes performing a principal component analysis to identify a set of linearly independent principal components.

19. The surface marking compliance system of claim 11, wherein the one or more factor-specific decay rates include decay rates for one or more of decay factors selected from a group of decay factors comprising: a plow decay factor corresponding to a number of times the surface marking was plowed; a solar decay factor corresponding to a solar energy exposure of the surface marking, a wind decay factor corresponding to a wind exposure of the surface marking; a position factor corresponding to a position of the surface marking relative of a reference point; an elevation decay factor corresponding to an elevation of the surface marking; a thermal decay factor corresponding to a temperature associated with the surface marker; an icing decay factor corresponding to freezing temperatures to which the surface marker is exposed; a marking type decay factor corresponding to a type of the surface marking; and a marking composition decay factor corresponding to a composition of the surface marking.

20. The surface marking compliance method of claim 19, wherein:
the surface marking comprises a highway marking selected from: an edge marking, a center line marking, and a lane marking.
